(19) United States
(12) Patent Application Publication
(10) Pub. No.: US 2015/0245110 A1
(43) Pub. Date: Aug. 27, 2015

(54) MANAGEMENT OF INVITATIONAL CONTENT DURING BROADCASTING OF MEDIA STREAMS

(71) Applicant: Apple Inc., Cupertino, CA (US)

(72) Inventors: Thomas Alsina, Mountain View, CA (US); David T. Wilson, Campbell, CA (US); Kenley Sun, Cupertino, CA (US); Sagar A. Joshi, San Jose, CA (US)

(73) Assignee: Apple Inc., Cupertino, CA (US)

(21) Appl. No.: 14/186,764

(22) Filed: Feb. 21, 2014

(51) Int. Cl. H04N 21/81; H04N 21/435

(52) U.S. Cl. CPC H04N 21/812; H04N 21/435

(57) ABSTRACT

Systems, methods, and computer-readable storage media for managing invitational content associated with broadcast media streams. Metadata is added to a broadcast media stream, in the form of tags, which can be used to present and track invitational content items in the broadcast media stream. The metadata in the tags can then be used, along with device information to generate notifications which can be utilized to generate exposure statistics for the media stream. In some configurations, the tags can be configured to invoke the presentation of an additional invitational content item.

### TECHNICAL FIELD

The present technology pertains to broadcasting of media streams, and more specifically pertains to management of invitational content during broadcasting of media streams.

### BACKGROUND

Digital advertising is widely used by advertisers to market their products via network devices, such as mobile phones and tablet computers. Given the widespread availability of these devices as well as network connectivity, digital advertising can be an extremely effective way for advertisers to reach a wide mass of potential customers and induce numerous users to purchase their products. By targeting users with effective digital advertisements, advertisers can yield large financial returns from their digital advertisements. Not surprisingly, many advertisers continuously measure the performance of their advertisements to understand how, if necessary, they can optimize their advertisements for a better performance.

In the case of a broadcasted media stream (e.g., a media stream of a live radio broadcast or broadcast of a live event), it is difficult to supply providers with meaningful information regarding exposure of users to content that is embedded bedded within the media stream, such as advertisements that are a part of the media stream. Typically, a media server forwards the media stream to devices that have little knowledge regarding the content of the broadcast media stream. Accordingly, the media server typically cannot determine if and when users have been exposed to an advertisement embedded within the media stream, e.g., an advertisement during the program being broadcasted. In fact, in some types of content distribution networks, the network is configured only to provide broadcast distribution of particular segments. Accordingly, the network may not have any way to reliable determine if or which client devices are receiving the media stream. One solution is to continuously track how and when users access the media stream and thereafter provide such information to the third party content provider. However, one issue is privacy, as this solution would require dissemination of a large quantity of user information to a third party. Another issue is that the concurrent, continuous tracking the behaviors of multiple users can be unwieldy in the case of a live event being provided to such users via a broadcast media stream, where the number of users can easily reach into the tens or hundreds of thousands of users.

### SUMMARY

Additional features and advantages of the disclosure will be set forth in the description which follows, and in pat will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein. The approaches set forth herein can be used.

The approaches set forth herein can be utilized to monitor users' exposure to invitational content embedded within a media stream broadcasted to multiple users, such as a media stream of a live event. In particular, metadata can added to a media stream, in the form of tags, and the tags can be used to monitor the presentation of invitational content items to user. Based on such monitoring, advertisers and other interested parties can more accurately monitor the number and types of users receiving the invitational content items. Disclosed are systems, methods, and non-transitory computer-readable storage media for managing invitational content in accordance with these concepts.

A first aspect of the present technology is the monitoring and generating of exposure statistics for invitational content items embedded in broadcast media streams. This monitoring of invitational content is performed by first broadcasting to user devices, via a media server or other network entity, a media stream consisting of a sequence of segments and associated tags. The sequence of segments provides the actual content of the media stream, such as the audio or video information for a broadcasted event. Such events can include radio broadcasts, telecasts, or any other type of broadcast event, whether live or pre-recorded. The media stream can further include tags associated with at least some of the segments. These tags can include metadata that provides information regarding the contents of any embedded invitational content, such as advertisements. The tags can further include metadata that provides information regarding the position of the embedded invitational content within the media stream, i.e. within the broadcasted event.

Next, in response to the broadcast of the segments of the media stream, notifications can be generated for each of the user devices being provided the media stream when a tag is encountered. The notifications can include the information in the tags, as well as information regarding the devices encountering the tags. The notifications can be generated by the user devices or the media server. Thereafter the notifications can be forwarded to an analysis/metrics system for processing.

After the notifications are received at the analysis/metrics system, the notifications can be used to generate exposure statistics for the media stream. In particular, based on the number of notifications received for each tag in the media stream and the device information associated with the notifications, various statistics and measures can be generated to characterize the extent to which users were exposed to the event and/or the invitational content items embedded in the media stream. Thereafter, these exposure statistics can be forwarded to interested parties for further analysis and use.

In some configurations, the notifications can also be utilized to generate additional invitational content for the user devices. That is, the notifications can be utilized to request additional invitational content. In some cases, the content can be delivered directly to the device from an advertisement server or other content delivery system. In other cases, the content can be provided to a media server, where the media server can attempt to insert such content into the media stream itself. In such configurations, there can be customization on a device-by-device level or a group-by-group level.

### BRIEF DESCRIPTION OF THE DRAWINGS

In order to describe the manner in which the above-recited and other advantages and features of the disclosure can be obtained, a more particular description of the principles briefly described above will be rendered by reference to specific configurations thereof which are illustrated in the appended drawings. Understanding that these drawings depict only exemplary configurations of the disclosure and are not therefore to be considered to be limiting of its scope, the principles herein are described and explained with additional specificity and detail through the use of the accompanying drawings in which:

FIG. 1 shows an exemplary network configuration, wherein electronic devices communicate for purposes of exchanging content and other data;

FIGS. 2A, 2B, and 2C show a media streams configured in accordance with the present technology;

FIG. 3 shows a flowchart of steps in an exemplary method for broadcast a media stream in accordance with the present technology;

FIG. 4 is a flowchart of steps in an exemplary method for processing notifications in accordance with the present technology;

FIG. 5 shows an alternate configuration of the components in FIG. 1 providing a system that supports the delivery of additional invitational content to user devices in accordance with the present technology;

FIG. 6 shows an exemplary configuration of a system for delivery of invitational content to user devices or terminals in accordance with the present technology;

FIG. 7 is a flowchart of steps in an exemplary method for generating notifications and for optionally causing the presentation of additional invitational content items at one of user devices;

FIG. 8 shows an alternate configuration of the components in FIG. 1 providing a system that supports the insertion of additional invitational content into a broadcast media stream in accordance with the present technology;

FIG. 9 is a flowchart of steps in an exemplary method 900 for inserting advertisements and other invitational content items into a broadcast media stream in accordance with the present technology; and

FIG. 10A, and FIG. 10B illustrate exemplary possible system configurations for implementing one of more aspects of the present technology.

### DESCRIPTION

Various configurations of the disclosure are discussed in detail below. While specific implementations are discussed, it should be understood that this is done for illustration purposes only. A person skilled in the relevant art will recognize that other components and configurations may be used without parting from the spirit and scope of the disclosure.

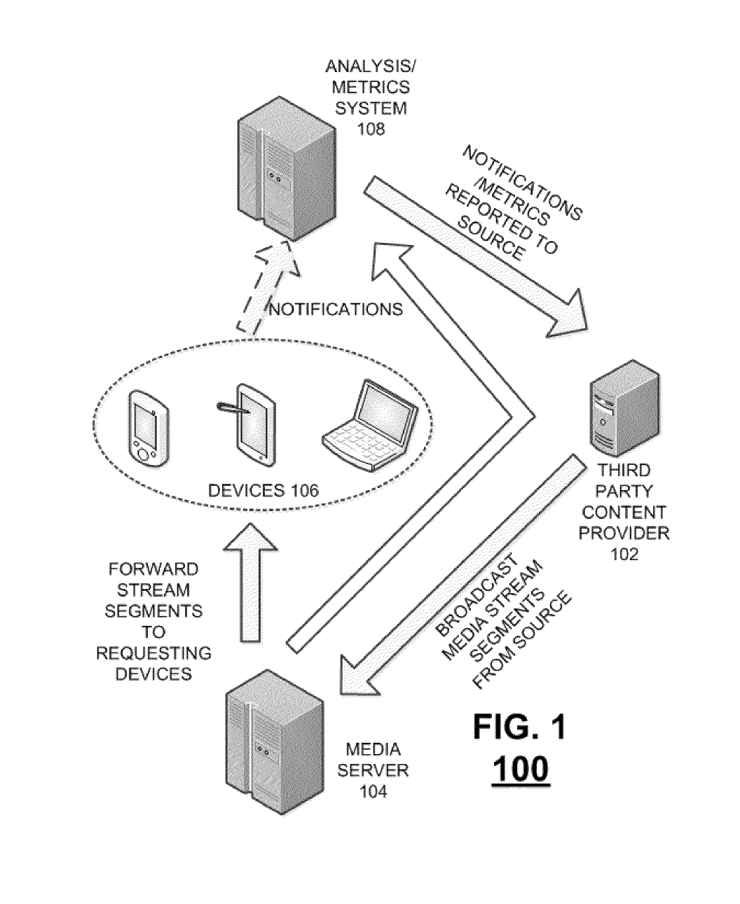

The disclosed technology addresses the need in the art for accurately and efficiently providing feedback to third party content providers regarding a media stream being broadcast by a media server to a collection of users. In particular, disclosed are systems, methods, and non-transitory computer-readable storage media for providing feedback to such third party content providers. Additionally, the disclosed technology also addresses the need in the art for inserting additional or replacement invitational content items into a media stream being broadcast to users. As noted above, one aspect of the present technology is a methodology for providing feedback to third party content providers regarding the exposure to users of embedded content. This process is described below with respect to FIGS. 1-4.

FIG. 1 shows an exemplary network configuration 100, wherein electronic devices communicate for purposes of exchanging content and other data. The elements in FIG. 1 can be configured for use on a wide area network. However, the present principles are applicable to a wide variety of network configurations that facilitate the intercommunication of electronic devices. For example, each of the components of in FIG. 1 can be implemented in a localized or distributed fashion in a network. As shown in FIG. 1, configuration 100 can include a third party content provider 102, a media server 104, user devices 106, and an analysis/metrics system 108.

In operation, the third party content provider 102 supplies a media stream to the media server 104. The media stream can be provided in a variety of ways. For example, in one configuration, the third party content provider 102 can supply the media stream using a streaming protocol, such as Real Time Transfer Protocols (defined by IETF RFC 3550) or the HTTP Live Streaming protocol developed by Apple, Inc. of Cupertino, Calif., in which the third party content provider 102 or media server 104 supply the media stream in chunks or segments. However, the present disclosure also contemplates that other streaming protocols and technologies can also be used with the present technology. In response to receiving the media stream, the media server 104 can forward to media stream to one or more of the devices 106 requesting access to the media stream.

In the present disclosure, the various aspects of the present technology will be primarily described with respect to a media stream of an event that is provided by the third party content provider 102 to a media server 104 and that is forwarded in real-time (or near real-time) to the devices 106 by media server 104 so that the devices 106 receive the media stream synchronously or nearly synchronously. However, the present technology is not limited in this regard. That is, the present disclosure contemplates that the various features of the present technology can be utilized even in cases where the media server 104 buffers some or all of the media stream and thereafter provides the media stream asynchronously to the various devices 106. Moreover, the content of the media stream need not be live. Rather, the media stream can be a broadcast of pre-recorded material.

It should be noted that in some configurations, the media server 104 is not configured to forward segments of the media stream to the devices 106. Rather, in such configurations, the media server can be utilized to provide the devices 106 with location information associated with the third party content provider 102, such as a pointer, a network address, etc. In some configurations, the location information can be specific for a particular one of devices 106. Thereafter, the location information can be utilized by the devices 106 to access the media stream directly from the third party content provider 102.

As noted above, in response to receiving the media stream, the media server 104 can forward to media stream to one or more of the devices 106 requesting access to the media stream. The present disclosure contemplates that the media server 104 can be configured in a variety of ways. For example, the media server 104 can be part of an online media store that provides streaming services, such as the ITUNES MUSIC STORE from Apple, Inc. of Cupertino, Calif. In another example, the media server 104 can be associated with a media streaming service, such as ITUNES RADIO, provided by Apple, Inc. of Cupertino Calif. Moreover, although media server 104 illustrated in FIG. 1 as a single component, the present disclosure contemplates that media server 104 can be implemented in a localized or distributed fashion over a network.

User devices 106 can be in communication with the media server 104, over a network connection, to request access to and receive the media stream from third party content provider 102. User devices 106 can be any network enabled client devices, such as desktop computers; mobile computers; handheld communications devices, e.g. mobile phones, smart phones, tablets; smart art televisions; settop boxes; and/or any other network enabled computing devices. The user devices 106 can be configured to invoke a client application, locally or remotely, to enable access to the content of the media stream. In operation, the user devices 106 can individually exchanges messages over a network connection with the media server 104 to request and obtain access to the media stream. The present disclosure contemplates that such an exchange of messages can include an authentication process to ensure a requesting one of the user devices 106 is entitled to access the media stream. In response to successfully exchanging messages, the devices 106 can begin to receive the media stream via media server 104.

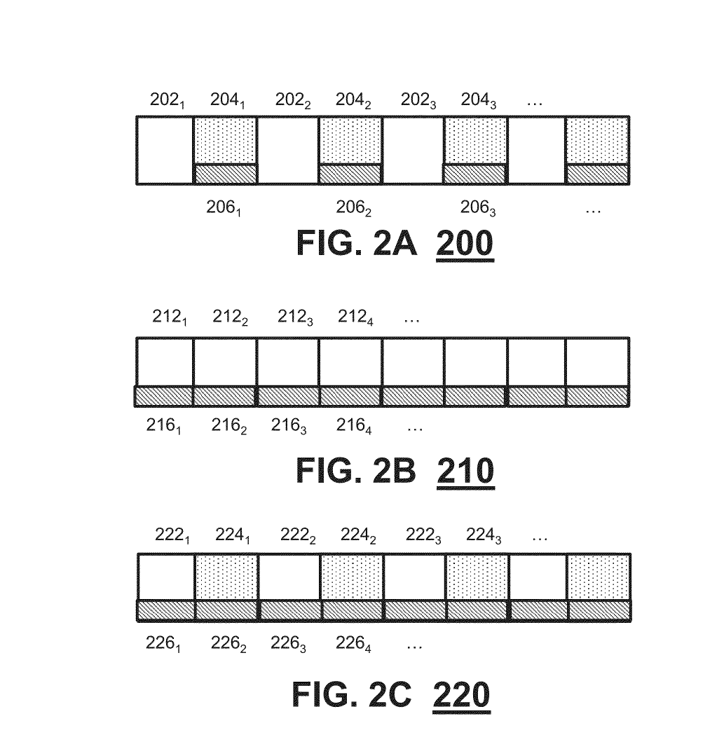

As noted above, one aspect of the present technology is enabling the generating of data that can be utilized, directly or in a processed form, by the third party content provider to review who received particular portions of the content in the media stream. In the present technology, this is accomplished by providing the means for generating notifications to be generated when particular content of interest is forwarded to user devices 106. Specifically, the present technology involves the insertion of tags within the media stream. A configuration of a media stream in accordance with the various configurations is illustrated with respect to FIGS. 2A, 2B, and 2C.

FIG. 2A shows a media stream 200 configured in accordance with the present technology. In particular, the media stream 200 consists of a sequence of segments 202₁, 204₁, 202₂, 204₂ . . . defining the content of the media stream 200. In the case of media stream 200, the segments correspond to a common configuration for a commercial broadcast. That is, a primary content segment 202ᵢ, e.g., content of a radio or television program, followed by a secondary content segment 204ᵢ, e.g., content of one or more advertisements. In the present technology, the content of the media stream is augmented. In particular, as shown in FIG. 2A, tags 206₁, 206₂ . . . are provided that correspond to secondary content segments 206₁, 206₂, . . . . The tags can be utilized to store metadata associated with the secondary content segments. This stored metadata can include information regarding the content within a second content segment. However, this metadata can also include information regarding the position of the secondary content segment with respect to the media stream. For example, time information or content information of the associated primary content segment. It should be noted that the configuration of FIG. 2A is presented by way of example only. That is, the present disclosure contemplates a variety of configurations for a media stream and the information included in the tags.

In a first example, FIG. 2B shows a media stream 210 configured in accordance with the present technology. In particular, the media stream 210 consists of a sequence of segments 212₁, 212₂, 212₃. . . defining the content of the media stream 210. In this example, each of the segments constitutes primary content, such as when streaming a movie or music without commercial interruption. In this case, there may be product placements or other content of interest within the media stream. Accordingly, in some configurations of the present technology, tags 216₁, 216₂, 216₃, . . . can be associated with each of (or a portion of) segments 212₁, 212₂, 212₃, . . . . The tags can be utilized to store metadata associated with the content of interest within the primary content segments. Along with such information, this metadata can also include information regarding the position of the secondary content segment with respect to the media stream. For example, time information or content information for primary content associated with the content of interest.

In a second example, FIG. 2C shows a media stream 220 configured in accordance with the present technology. In particular, this shows a media stream combining the features of media stream 200 and 210. That is, for each of the segments 202ᵢ and 204ᵢ, an associated tag 206ᵢ is provided. These tags can be configured as described above with respect to FIGS. 2A and 2B. It should be noted that although the arrangement of segments in FIGS. 2A and 2C may imply that a segment of primary content is followed by one and only one segment of secondary content, the present technology is not limited in this regard. Rather, a media segment can include any number and arrangement of primary and secondary content segments.

It should be noted that although FIGS. 2A-2C illustrate that tags must be located in the media stream at the particular segments for which the information therein is referring to, the present technology is not limited in this regard. Rather, the tags can be inserted at any point in the media stream and can refer to any segment of the media stream.

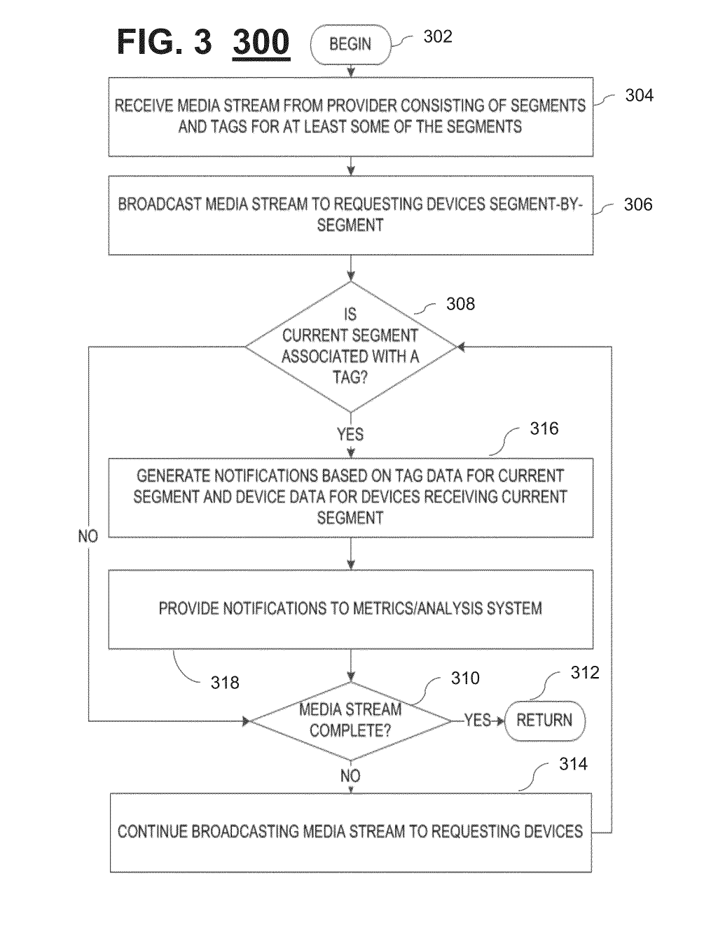

Referring back to FIG. 1, the present disclosure contemplates that media server 104 will receive the media stream in a tagged format. Accordingly, this can involve the third party content provider 102 or other entity inserting the tags into the media stream prior to delivery of the media stream to media server 104. Once the media server 104 receives the tagged media stream, processing, i.e., broadcasting, of the tagged media stream can begin and notifications can be generated. This process is described below with respect to FIG. 3.

FIG. 3 shows a flowchart of steps in an exemplary method 300 for broadcast a media stream in accordance with the present technology. The method 300 begins at step 302 and continues on to step 304. At step 304, the media server 104 receives the media stream from a third party content provider 102. As noted above, the media stream consist of a sequence of segments that provide primary content and, optionally, secondary content. As further noted above, the media stream also includes tags for one or more of the segments. Also, although FIG. 1 contemplates that third party content provider 102 will forward the media stream directly to media server 104, the present disclosure further contemplates that one or more intermediary devices may exist between media server 104 and third party content provider 102.

Subsequent to, or concurrently with step 304, the media server 104 can begin to broadcast the media stream to one or more of user devices 106 at step 306. The present disclosure contemplates that the ones of user devices 106 can be a set of user devices for which access to the media stream is requested collectively or individually. Further, although FIG. 1 contemplates that the media server 104 will forward the media stream directly to user devices 106, the present disclosure contemplates that one or more intermediary devices may exist between media server 104 and user devices 106.

Once broadcasting of the media stream to user devices 106 is started at step 306, the method can proceed to step 308. At step 308, a determination can be made as to whether a segment being broadcast to user devices is associated with a tag.

If there is no tag associated with the segment at step 308, the method 300 can proceed to step 310. A determination can then be made at step 310 of whether or not the broadcasting of the media stream is complete or ended. For example, this can occur when the third party content provider 102 halts the forwarding of segments or signals that no further segments are to be provided. If the broadcast is completed, the method can proceed to step 312 and resume previous processing, including repeating method 300. If the broadcasting has not been completed, the method can proceed to step 314 and the media server 104 can continue the broadcasting to the ones of user devices 106 requesting access to the media stream. The method 300 then proceeds to step 308 to repeat the determination of whether or not a segment broadcast to users includes a tag.

If there is a tag associated with the segment at step 308, the method 300 can proceed to step 316. At step 316, a notification is generated for each device to which the media stream is currently being broadcast to. The notification can be based at least on the tag data in the detected tag and device data associated with the device. Thus, the notification identifies the content of interest based on the tag, as previously discussed, but also data associated with the device receiving the segment. For example, such device data can include channel characteristics, demographic characteristics, behavioral characteristics, and spatial-temporal characteristics associated with the device or the user associated with the device. In some configurations, the generation of the notification can include anonymizing the device data so that the actual device associated with the notification is unknown to the analysis/metrics system 108. Once the notifications are generated at step 316, the notifications can be forwarded to analysis/metrics system 108 at step 318. Thereafter, the method can proceed to step 310 for further processing, as described above.

The present disclosure contemplates that the notifications can be generated in a variety of ways in the present technology. As shown in FIG. 1, one configuration consists of the notifications being generated by the media server 104, i.e., a server-side implementation. In general, a media server 104 servicing device 106 will have some knowledge of the characteristics of the requesting ones of devices 106 and potentially some knowledge of the users associated with such devices. For example, the media server 104 can require a registration process to allow a user device to receive a media stream from the media server 104. Thus, the media server 104 can detect the tags in the media stream as they are being transmitted to requesting ones of the user devices 106. Thereafter, for such user devices, the media server 104 can combine the information in the tags with device data available at the media server 104 to generate and forward the notifications to the analysis/metrics system 108.

The present disclosure also contemplates that notifications can instead be generated by the user device 106, i.e., a client-side implementation. That is, each one of user devices 106 receiving the media stream can detect the tags in the media stream as they are being received from the media server 104. Thereafter, the information in the tags can be combined at such devices with the device data to generate and forward the notifications to the analysis/metrics system 108.

The present disclosure also contemplates that a combination of methods can be used. For example, if only a portion of the user devices 106 are capable of generating the notifications, the task can be divided, as needed, between the devices 106 and the media server 104 to ensure that a notification is being received for all user devices receiving the media stream. In another example, both device 106 and the media server 104 can generate notifications. In such a configuration, in the event a notification is not received from one of devices 106, the notification from the media server 104 can be used in its place.

With respect to the generation of the notifications, the present disclosure also contemplates that this may be accomplished in a variety of ways. In particular, the same or different types of notification can be generated for each of the user devices 106 receiving the media stream. In the case of the former, this can be accomplished by configuring the media server 104 to format and generate the notifications in the same way, regardless of the device. Alternatively, the user devices 106 can also be configured in this fashion. In the case of the latter, different types of notifications can be generated for different devices. For example, in the event that a notification format or configuration needs to be altered because of changes in the analysis/metric system 108, a software update may be required for each of user devices 106 and each media server 104 (or component thereof). However, there may be instances in which such updates are not possible. Accordingly, the analysis/metrics system 108 can be configured to receive the notifications in different formats or configurations and convert them as needed for processing at analysis/metrics system 108.

Additionally, FIG. 1 contemplates that all notifications are transmitted to a single analysis/metrics system 108. However, the present disclosure contemplates multiple analysis/metrics systems can be provided. Moreover, the present disclosure also contemplates that notifications for different ones of user devices 106 may be associated with such different analysis/metrics systems. For example, multiple systems can be provided, each associated with a different type of user device. However, the present technology is not limited in this regard and divisions can be based on any other criteria associated with the user devices.

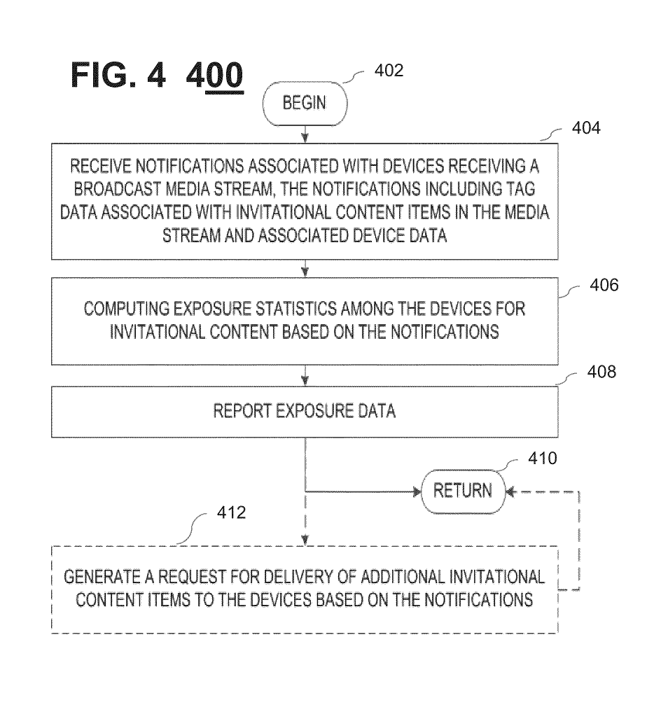

As noted above, the notifications are forwarded to analysis/metrics system 108 for processing. An exemplary operation of such a system is described below with respect to FIG. 4. FIG. 4 is a flowchart of steps in an exemplary method 400 for processing notifications. Method 400 begins at step 402 and continues to step 404. At step 404, the notifications generated by the user devices 106, the media server 104, or both, can be received at the analysis/metrics system 108. As described above, the notifications include tag data for a tagged segment and device data for the one of user devices 106 associated with the notification. Thus, without needing to gather or monitor all events and actions at each of user devices 106, the analysis/metrics system 108 receives the information indicating which of devices 106 received a particular segment, the tag data identifying the item(s) of interest n the segment and its relation to the media stream, and the characteristics of the devices.

Once the notifications for a segment are received at step 404, exposure statistics for the item(s) of interest or other features of the media stream can be computed at step 406. For example, if a tag in a broadcast media stream is associated with a particular advertisement, the tags received from user devices 106 associated with such a tag can be used to quantify how many users were exposed to the particular advertisement, as well as quantifying the exposure to the advertisement based on channel characteristics, demographic characteristics, behavioral characteristics, and spatial-temporal characteristics.

The present disclosure also contemplates that notifications associated with other tagged segments can be combined with the notifications for a current segment to develop other types of exposure statistics. For example, the notifications from other segments can be used to gauge the user's exposure to a live event associated with the broadcast media stream or exposure to a campaign of multiple advertisements provided during the event. With respect to the user's exposure to the live event, the present disclosure contemplates that the tags can be located throughout the media stream. Thus, if all or substantially all possible notifications are generated for a particular user device, it can be inferred that the user device was sent all or substantially all segments of the broadcast media stream and that the user associated with the user device was exposed to substantially all portions of the event associated with the media stream. In contrast, if only a portion of the possible notifications are generated for a user device, it can be inferred that the user device was sent only a portion of the segments of the broadcast media stream and that the user associated with the user device was exposed to only part of the event. Accordingly, if the notifications for each tag in the broadcast media stream are aggregated, an indication of the number of users exposed to each portion of the event can be estimated based on the received notifications. Other viewing or listening statistics can also be computed based on the notifications. Additionally, exposure statistics for the different segments of the broadcast media stream, i.e., the different portions of the event, can be evaluated with respect to channel characteristics, demographic characteristics, behavioral characteristics, and spatial-temporal characteristics.

A similar approach can be utilized to track the exposure of users to a campaign. That is, if an advertiser places advertisements in certain segments of a media stream associated with the live event, exposure statistics for these select segments can be evaluated. As described above, these can be based on the number of users as well as any channel characteristics, demographic characteristics, behavioral characteristics, and spatial-temporal characteristics.

Once exposure statistics are computed at step 406, the method 400 can proceed to step 408 and report the exposure statistics. In some configurations, such reporting can be provided directly to the third party content provider 102, as illustrated in FIG. 1. However the present disclosure also contemplates that the reporting information can be provided to other entities (not illustrated in FIG. 1) as well. For example, exposure statistics regarding the exposure of users to the a live event associated with a broadcast media stream can be forwarded to the third party content provider 102 and exposure statistics associated with advertisements embedded within the broadcast media stream can be forwarded to entities associated with the advertisements. The method 400 can then proceed to step 410 and resume previous processing, including repeating method 400.

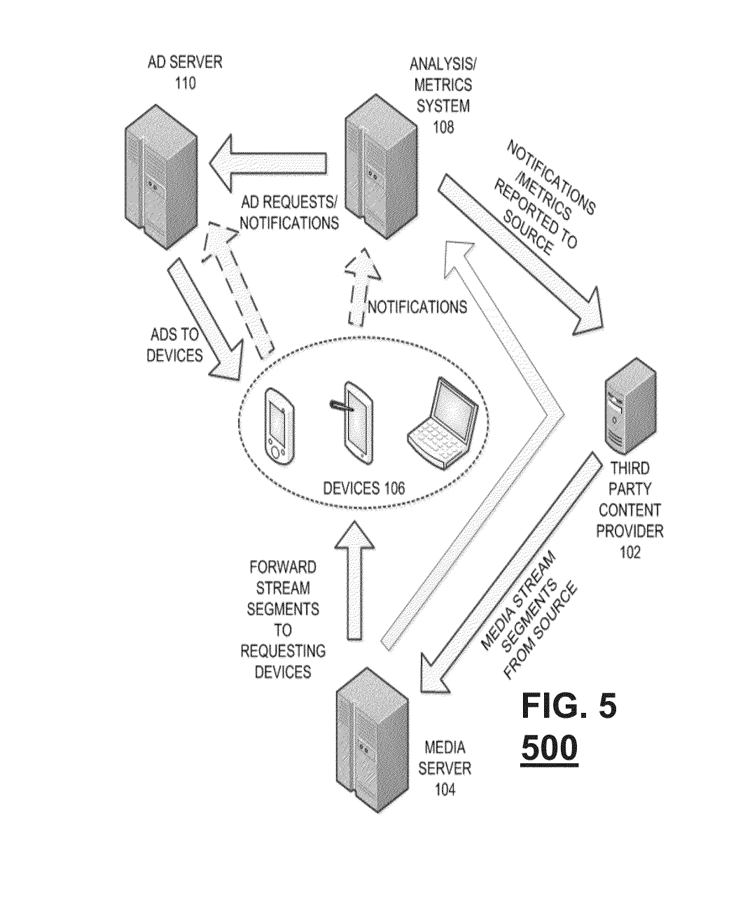

In some configurations, the notifications and exposure statistics can be utilized to generate additional invitational content for the user devices. That is, based on the exposure statistics, a request for delivery of additional invitational content items can be generated at step 412 before proceeding to step 410. This request can be provided to a content delivery system, such as advertisement server 110, as illustrated in FIG. 5. FIG. 5 shows an alternate configuration of the components in FIG. 1 providing an exemplary system 500 that supports the delivery of additional invitational content to user devices 106. As shown in FIG. 5, the analysis/metrics system 108 can, in response to the receipt of notifications from user devices 106 or media server 104, generate requests for the advertisement server 110 to deliver invitational content to the user devices. These requests can include an identification of the device from the device data and information regarding the current context at the device, e.g., the portion of the live event associated with the device. Alternatively, the analysis/metrics system 108 can simply forward the notifications for the user devices 106 to the advertisement server 110, which substantially includes the same type of information. In either case, the advertisement server 110 can process this information and thereafter select and forward an appropriate advertisement for the device associated with the request.

The present disclosure also contemplates that while the delivery of such advertisements can be done on a device-by-device level, the present technology is not limited in this regard. That is, in some configurations the analysis/metrics system 108 can request a same or nearly the same advertisement be delivered to a group or devices. Thus, the advertisement server 110 can them select the appropriate advertisement for each device based on the parameters set forth in the request. The present disclosure contemplates that in some cases there may not be advertisements available for certain devices due to technical, legal, or other restrictions. In such cases, the advertisement server 110 can include logic to select an alternate advertisement that is appropriate based on the request. For example, if the request specifies a certain advertisement or an advertisement from a particular campaign, the advertisement server 110 can select an advertisement from the same advertiser.

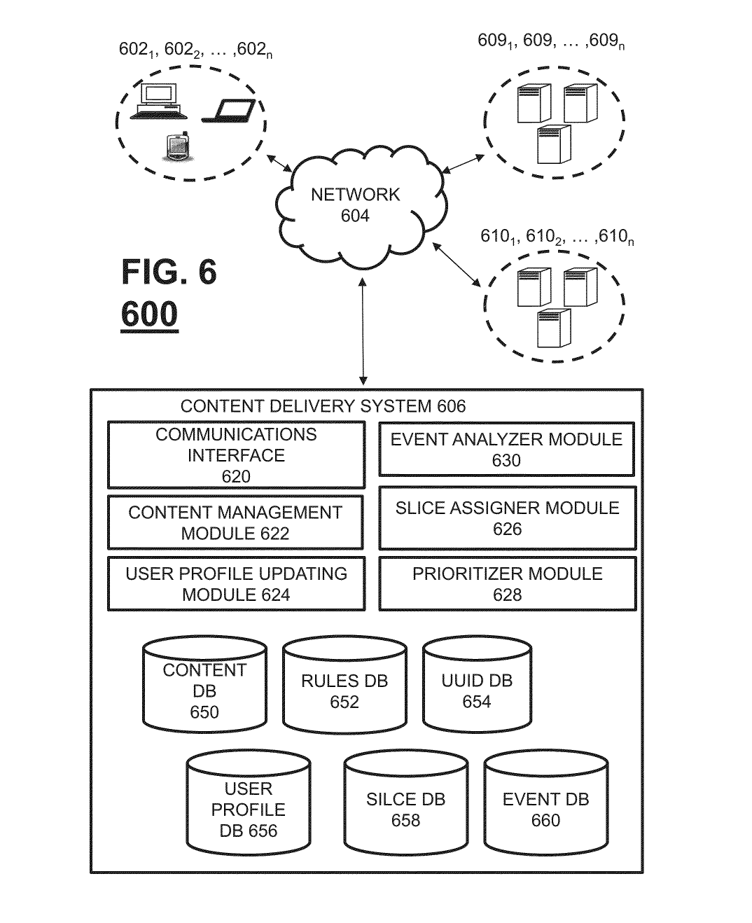

One configuration of an exemplary content delivery system suitable as advertisement server 110 is shown in FIG. 6. FIG. 6 shows an exemplary configuration of a system 600 for delivery of invitational content to user devices or terminals. In system 600, invitational content can be delivered to user devices or terminals 602₁, 602₂ . . . 602ₙ (collectively “102”) connected to a network 604 by direct and/or indirect communications with a content delivery system 606, which can server as advertisement server 110. As noted above with respect to FIG. 1, user terminals 602 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 606 can concurrently accept connections from and interact with multiple user terminals 602.

The content delivery system 606 can receive a request for electronic content, such as a web page, an application, a media item, etc., from one of user terminals 602. Thereafter, the content delivery system 606 can assemble a content package and transmit the assembled content page to the requesting one of user terminals 602. To facilitate communications with the user terminals 602 and/or any other device or component, the content delivery system 606 can include a communications interface 620.

The content delivery system 606 can include a content management module 622 to facilitate the generation of an assembled content package. Specifically, the content management module 622 can combine content from one or more primary content providers 609₁, 609₂ . . . 609ₙ (collectively “609”) and content from one or more secondary content providers 610₁, 610₂ . . . 610ₙ (collectively “610”) to generate the assembled content package for the user terminals 602. For example, in the case of a web page being delivered to a requesting one of user terminals 602, the content management module 622 can assemble a content package by requesting the data for the web page from one of the primary content providers 609 maintaining the web page. For the invitational content on the web page provided by the secondary content providers 610, the content management module 622 can request the appropriate data according to the arrangement between the primary and secondary content providers 609 and 610. Additionally, the content management module 622 can create content packages that contain content from a single content provider. That is, a content package can contain only primary content or a content package can contain only secondary content. However, the content package is not limited to the content from content providers 609 and 610. Rather, the content package can include other data generated at the content delivery system 606. In some configurations, the content delivery system 606 can preselect the content package before a request is received.

An assembled content package can include text, graphics, audio, video, executable code, or any combination thereof. Further, an assembled content package can include invitational content designed to inform or elicit a pre-defined response from the user. In some configurations, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various configurations are not limited in this regard and the invitational content can include static invitational content that neither varies over time nor with user interaction. In the various configurations, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 602ᵢ. A subsequent content package can include one or more items of invitational content that can be presented to a user of the user terminal 602ᵢ while the user interacts with the app.

Although primary and secondary providers 609 and 610 are presented herein as separate entities, this is for illustrative purposes only. In some cases, the primary and the secondary content providers 609 and 610 can be the same entity. Thus, a single entity can provide both the primary and the secondary content.

The content management module 622 can be configured to request that content be sent directly from content providers 609 and 610. Alternatively, a cached arrangement can also be used to improve performance of the content delivery system 606 and improve overall user experience. That is, the content delivery system 606 can include a content database 650 for locally storing/caching content maintained by content providers 609 and 610. The data in the content database 650 can be refreshed or updated on a regular basis to ensure that the content in the database 650 is up to date at the time of a request from a user terminal 602ᵢ. However, in some cases, the content management module 622 can be configured to retrieve content directly from content providers 609 and 610 if the metadata associated with the data in the content database 650 appears to be outdated or corrupted.

In some configurations, the content database 650 can maintain content items for presentation at the user terminals 602. The content database 650 can also maintain content associations with specific places, such as locales. Moreover, the content database 650 can maintain database corresponding to specific items of content. The metadata can specify unique identifiers, location information, association information, ranking information, etc. The content database 650 can also maintain lists of content items filtered or selected based on specific rules or criteria. For example, the content database 650 can maintain lists of content items that are relevant to specific geographic areas, demographics, slices, etc.

As described above, content maintained by the content providers 609 and 610 can be combined according to a predefined arrangement between the two content providers, which can be embodied as a set of rules. In an arrangement where the content delivery system 606 assembles the content package from multiple content providers, the assembly rules can be stored in a rules database 652 in the content delivery system 606. The content management module 622 can be configured to assemble the content package for user terminals 602 based on these rules. The rules can specify how to select content from secondary content providers 610 and primary content providers 609 in response to a request from one of user terminals 602. For example, in the case of a web page maintained by one of primary content providers 609 and including invitational content, the rules database 652 can specify rules for selecting one of the secondary providers 610. The rules can also specify how to select specific content from the selected one of secondary providers 610 to be combined with the content provided by one of primary providers 609. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 602.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 602. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some configurations, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 606 can be configured to learn of or derive user characteristics from any number of other information sources. For example, in some configurations, the content delivery system 606 can derive or infer one or more user characteristic values from user characteristic values already known about the user.

In some configurations, the interactive content can be associated with one or more targeted slices. A targeted slice can be viewed as defining a space or region in k-dimensional space, where each of the k dimensions is associated with one of a plurality of user characteristics. In the various configurations, the k dimensions can include both orthogonal and non-orthogonal dimensions. That is, some of the k dimensions can overlap or can be related in some aspect.

In the various configurations, the content delivery system 606 can also include a unique user identifier (UUID) database 654 that can be used for managing sessions with the various user terminal devices 602. The UUID database 654 can be used with a variety of session management techniques. For example, the content delivery system 606 can implement an HTTP cookie or any other conventional session management method (e.g., IP address tracking, URL query strings, hidden form fields, window name tracking, authentication methods, and local shared objects) for user terminals 602 connected to content delivery system 606 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 654. The content delivery system 606 can analyze the attributes of requesting devices to determine whether such requests can be attributed to the same device. Such attributes can include device or group-specific attributes.

In some configurations, the content delivery system 606 can include a user-profile database 656. The user-profile database 656 can, at least in part, be constructed based on declared user characteristics related to one or more users. In some cases, the user-profile database may contain inferred or derived user characteristic values. The user-profile database 656 can be updated using a user-profile-updater module 624. In some configurations, the user-profile-updater module 624 can be configured to add additional profile data, update profile data, fill in missing profile data, or infer user characteristic values from declared data.

The user-profile-updater module 624 can also be configured to maintain the user profile database 656 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 624 can be configured to maintain the user profile database 656 to include only data from the last two to three months. However, the user-profile-updater module 624 can be configured to adjust the data in the user profile database 656 to cover any span of time. In some instances the user-profile-updater module 624 can update the profile database 656 in real-time. Alternatively, the user-profile-updater module 624 can be configured to set an expiration period on a subset of the data in the user profile database 656. For example, a policy can specify that user declared data is maintained as long as the user account is active, but user characteristic values based on location information expire after a specified period of time. In some cases, a user can set the expiration period. In some instances, the user-profile-updater module 624 can update the user profile database 656 at least every week, or every day. In some cases, the content delivery system 606 can receive a direct request to update one or more user profiles. The update request can come directly from the user's device or any other device capable of communicating with the content delivery system 606, such as other content delivery networks or websites. In some cases, the content delivery system 606 can receive an indirect request to update one or more user profiles. An indirect request can be the result of receiving new user characteristic values. An update request can occur at any time.

In some configurations, the content deliver system 606 can include a slice database 658 that is used to aid in selecting invitational content to target to users. The slice database 658 can store defined slices and associations between the slices and users and/or invitational content that should be targeted to users associated with the slices. As described above, a targeted slice can be defined based on one or more user characteristics or derivatives thereof and can be associated with one or more items of invitational content. Additionally, a targeted slice can be associated with one or more users. In some configurations, by associating a targeted slice with both a user and an item of invitational content, the delivery system can match invitational content with users. In some configurations, the content delivery system 606 can update the slice database 658 to add newly defined targeted slices or to delete targeted slices.

In some cases a targeted slice can be as simple as a single user characteristic identifier and a single user characteristic value. For example, the common demographic identifiers of gender, age, occupation, or income can each be used in defining corresponding targeted slices. A characteristic value can also be assigned to the identifier. For example, the values of male, 19, and student can be assigned to the user characteristics of gender, age, and occupation, respectively. However, more complex targeted slices can also be defined that consist of one or more identifiers with one or more values associated with each identifier. For example, a targeted slice can be defined to target a user with the following characteristics: gender, male; age, 19-24; location, Northern California or New York City. Additional exemplary slices are described throughout this disclosure. Furthermore, targeted slices can correspond to one or more slices that content providers are likely to easily understand and thus can quickly identify as being relevant to their content. Additionally, in some configurations, content providers 609 and 610 can define a custom targeted slice.

In some configurations, the content delivery system 606 can provide a slice assigner module 626. The slice assigner module 626 can apply a set of user characteristics associated with a user (including slices to which a user has been previously assigned) to assign the user to one or more targeted slices. The assigner module 626 can obtain the set of user characteristic values from the user profile database 654 and/or from the user's activities during the current session. The slice assigner module 626 can assign a user to one or more defined targeted slices in the slice database 658, or alternatively, a user can be assigned to a custom targeted slice defined to meet specific goals of a content provider.

Based on the assigned slices, the user profile database 656 can be updated to reflect the slice assignments. Additionally, the content delivery system 606 can use the slice assignments to select targeted content. In some cases, the user profile data in the user profile database 656 can change over time so the slice assigner module 626 can be configured to periodically update the slice assignments in the user profile database 656. The slice assignment update can be triggered at specified intervals, upon detection of a change in the user profile database 656, and/or upon detection of a specified activity in the content delivery system 606.

In some configurations, the content delivery system 606 can provide a prioritizer module 628. The prioritizer module 628 can perform a variety of prioritizing tasks based on the configuration of the content delivery system 606. In some configurations, the prioritizer module 628 can prioritize the targeted slices assigned to a user. The prioritization can be influenced by a number of factors, which can include the user's context, a content provider's campaign goals, and/or the content that is currently available for display to the user. A request to prioritize the targeted slices can be explicit or implicit and can be made by any component of the system 600. For example, a secondary content provider 610 can explicitly request that the content delivery system 606 prioritize the targeted slices or the request can be implicit as part of a request for a content package. The resulting prioritized list can be provided, for example, to the content management module 622, which can then use the information to assemble and deliver a content package. Additionally, the prioritized list can be stored, for example in the user profile, for later use.

The event analyzer module 630 can be configured to collect, store, generate, detect, receive, and analyze event data. In some configurations, the event data can include conversion event data, presentation data, impression data, and so forth. For example, the event analyzer module 630 can collect impressions or invitational content presentations at user terminals 602 and conversion events, such as purchases, downloads, subscriptions, and registrations. Each of the data items collected can be associated with a particular campaign of content. Moreover, each of the data items can chide a respective timestamp. For example, the event analyzer module 630 can detect conversion events and associate the detected conversion events with respective timestamps corresponding to times when the conversion events took place. Similarly, the event analyzer module 630 can detect an impression and associate the impression with a timestamp indicating when the impression took place.

The event analyzer module 630 can additionally collect or generate further information associated with an event, such as a conversion event or an impression. Moreover, the event analyzer module 630 can analyze any available information for events to associate one or more events with each other. For example, the event analyzer module 630 can analyze information associated with a conversion event to associate the conversion event with an impression event. In some cases, the event analyzer module 630 can generate record or reports correlating different events based on associated information, such as timestamps, for example. The event analyzer module 630 can also identify specific types of events, such as impressions, and credit those events with another correlated or corresponding event, such as a conversion event. In addition, the event analyzer module 630 can attribute specific events such as conversion events to an application or content item associated with a correlated or corresponding event, such as an impression or a content presentation event. Additional details for correlating, crediting, or associating events and attributing applications is further described below.

The content delivery system 606 can also include an event database 660 to store event data, such as data generated, collected, or analyzed by the event analyzer module 630. For example, the event database 660 can store conversion events, impressions, or content presentations associated with a campaign of content. In some cases, the event database 660 can store details relating to associations, correlations, or attributions determined or generated by the event analyzer module 630. Moreover, the event database 660 can store records, data, and information associated with campaigns of content and any associated event. Further, the event database 660 can store additional details associated with an event, such as a time stamp, statistics, a context, a description, an identifier, an association, a link, a content item, a token, metadata, etc.

While the content delivery system 606 is presented with specific components, it should be understood by one skilled in the art, that the architectural configuration of system 606 is simply one possible configuration and that other configurations with more or less components are also possible.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates configurations in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed configurations, the present disclosure also contemplates that the various configurations can also be implemented without the need for accessing such personal information data. That is, the various configurations of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

Referring back to FIG. 5, the ability to forward notifications or requests to the advertisement server 110 is not limited in the present technology to the analysis/metric system 108. Rather, as shown in FIG. 5, the user devices 106 can also forward requests or notifications to the advertisement server 110. Thus, the ability to invoke the presentation of an advertisement or other invitational content is not limited solely to the analysis/metrics system 108.

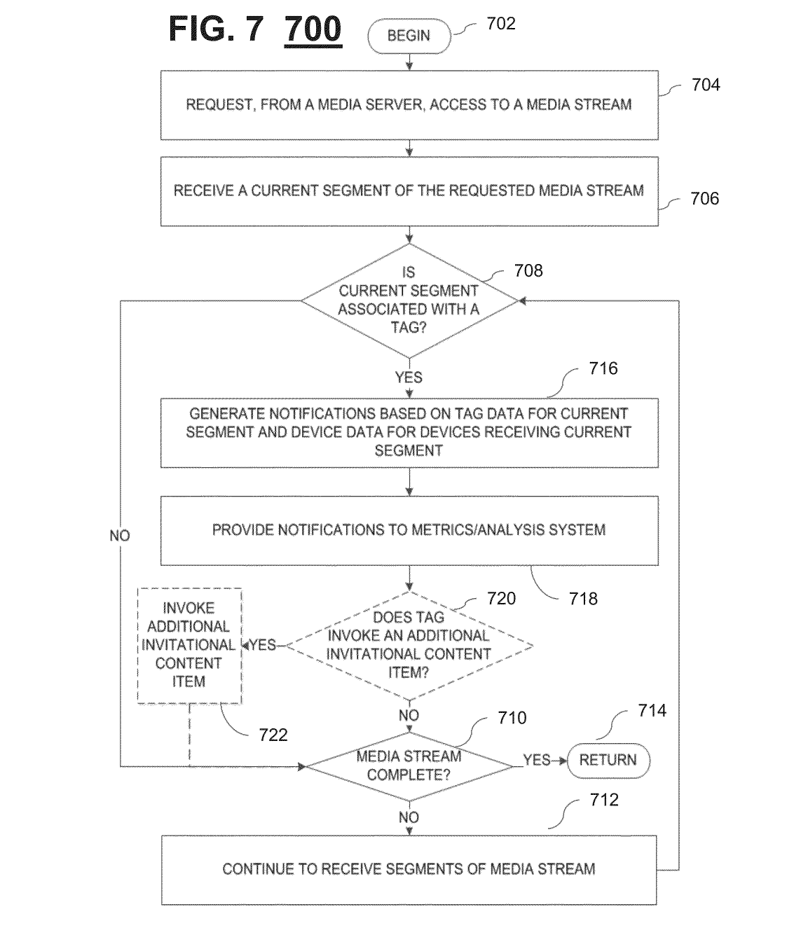

Turning now to FIG. 7, a more detailed description of the operation of the components in FIG. 5 for generating notifications and obtaining additional invitational content is shown in FIG. 7. FIG. 7 is a flowchart of steps in an exemplary method 700 for generating notifications and for optionally causing the presentation of additional invitational content items at one of user devices 106.

Method 700 begins at step 702 and proceeds to step 704. At step 704, a user device from user devices 106 can request, from media server 104, access to a broadcast media stream. Assuming that the broadcast media stream corresponds to a live event, the user device can receive the media stream at step 706, beginning with the current segment for the event. Thereafter, at step 708, a determination is made as to whether or not the current segment is associated with a tag.

If the current segment is not associated with a tag at step 708, the method proceeds to step 710. At step 710, it is determined whether the media stream is complete. If the media stream not complete, the user device can continue receiving segments at step 712 and continue to check for additional tags at step 708. If the media stream is complete, the method 700 can proceed to step 714 and resume previous processing, including repeating method 700.

Referring back to step 708, if a current segment is associated with a tag, the method 700 can instead proceed to step 716. At step 716, notifications can be generated based on the tag data and the device data. As previously noted, such notifications can also be generated by the media server 104. The notifications can then be forwarded to the analysis/metrics system 108 for processing at step 718. The processing can proceed as described above. The method can proceed to step 710 and proceed as described above.

As noted above, a tag can result in the invocation of an additional invitational content item. In some configurations, this can mean that the tag data is configured with instructions to cause the presentation of additional invitational content at the user device. Thus, the user device or the analysis/metric system 108, upon encountering such tag data, can be configured to forward a request or notification to the advertising server 110, which in turn delivers an advertisement to the user device. In another configuration, rather than relying on an instruction in the tag data, the user device or the analysis/metric system 108 can be configured to act in this manner automatically when a tag is encountered or a notification is generated. In some instances, this may only apply to certain tags or notifications.

In still another configuration, the invocation of an additional invitational content item may not involve the advertisement server 110 at all. Instead, the tag itself can include an additional item of invitational content, such as an advertisement, that is presented in response the user device encountering the tag. Thus, upon receiving the tag, the user device can extract the additional invitational content item from the media stream and present it at the user device.

In yet another configuration, the invocation of an additional invitational content item can involve obtaining or extracting the item at the client device, as described above, but presenting the item only if additional criteria are met. For example, certain invitational content items may only be presented if the user is performing some type of action with respect to the underlying application. For example, in the case of music event being streamed to client devices 106, there may be artwork presented at the client device 106 and the artwork may be configured to allow the user to interact with it to obtain additional information regarding the artist(s). The invitational content item can then configured to only be presented after the user interacts with the artwork. However, the present technology is not limited to criteria based solely on user interaction. In other configurations, the criteria can be criteria regarding channel characteristics, demographic characteristics, behavioral characteristics, and spatial-temporal characteristics.

The present disclosure contemplates that in certain circumstances the tag can be configured to cause invocation of an invitational content item for only certain user devices. That is, the tag may be configured to cause the item to be invoked only for device meeting certain criteria with respect to channel characteristics, demographic characteristics, behavioral characteristics, and spatial-temporal characteristics. Accordingly, a particular tag may only cause the invocation of additional invitational content items with only certain ones of user device 106.

Referring back to FIG. 7, the invocation of additional invitational content items can occur as follows. First, following or contemporaneously with steps 716 and 718, a determination can be made at step 720 as to whether tag or the tag data therein invokes the presentation of additional invitational content at the user device. If no such invocation is required, the method can proceed to step 710 and continue processing as described above. If an invocation is required, the method can proceed to step 722. At step 722, the additional invitational content item can be invoked. As described above, this can include causing an additional invitational content item to be obtained, such as an advertisement from advertisement server 110, or the extraction and presentation of the additional invitational content item from the tag in the media stream. Thereafter, the method can proceed to step 710 and continue previous processing, as described above.

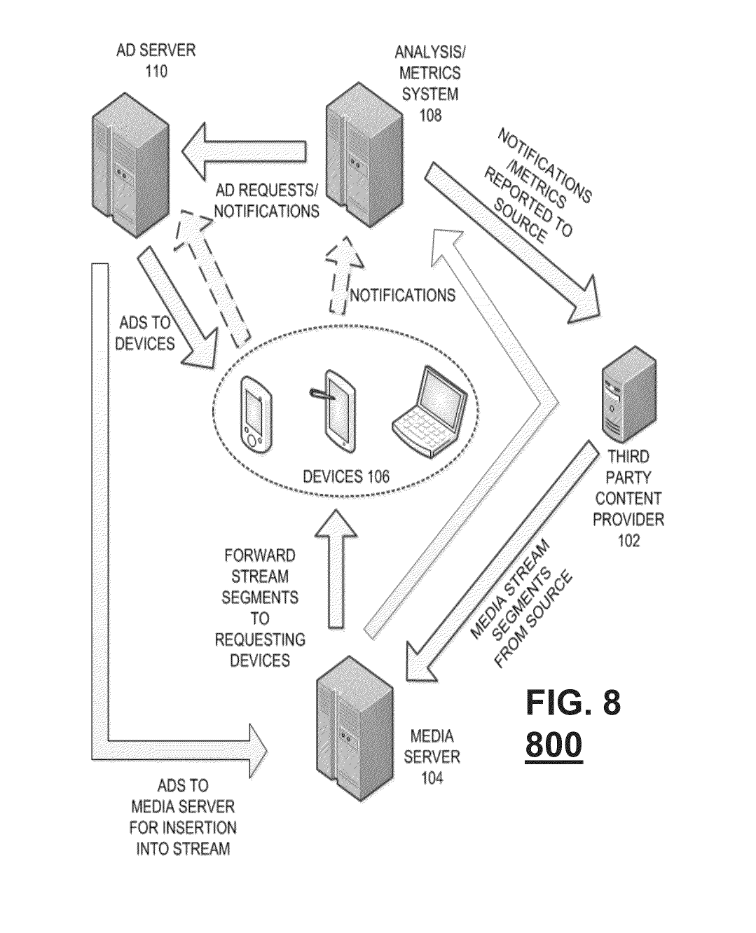

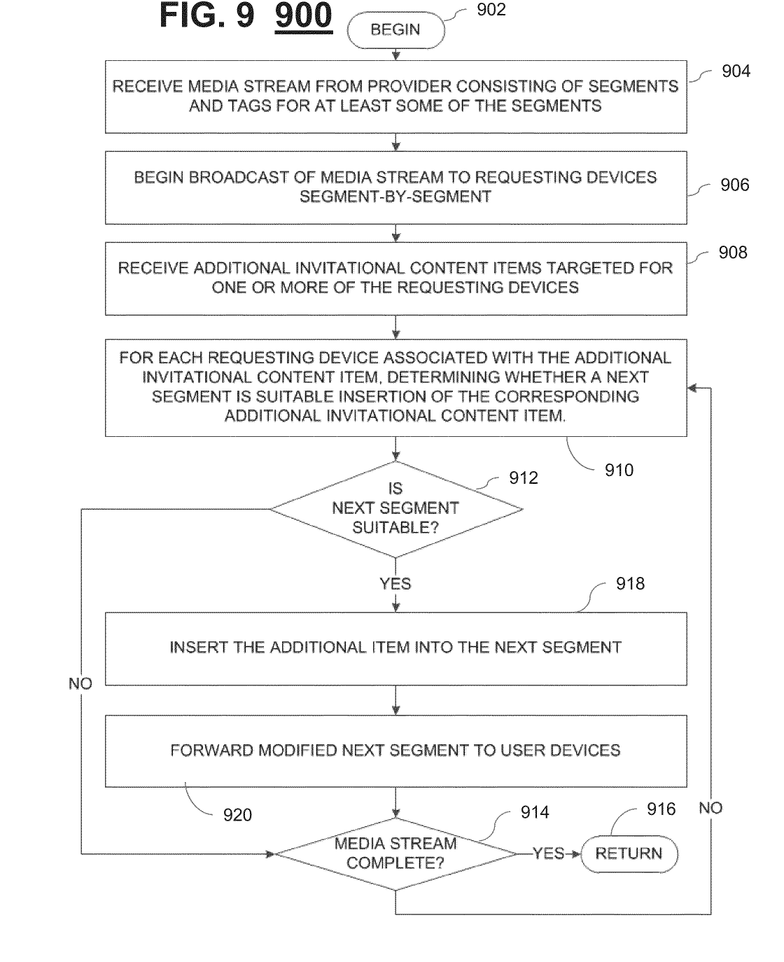

The description above has primarily dealt with scenarios in which the broadcast media stream is received from third party content provider 102 at the media server 104 and is thereafter provided to user devices 106 upon request. That is, the broadcast media is delivered to user devices without any modification. However, another aspect of the present technology is to provide the ability to modify the broadcast media stream to incorporate additional invitational content items for user device 106, including advertisements. This process is described below with respect to FIGS. 8 and 9.

Turning first to FIG. 8, there is shown therein an alternate configuration of the components of FIG. 1 or FIG. 5 providing an exemplary system 800 for supporting the insertion of additional invitational content into a broadcast media stream. In particular, as with FIG. 5, the configuration of FIG. 8 also includes a content delivery system, advertisement server 110. The operation of system 800 is substantially system to that already described above with respect to FIGS. 1 and 5. However, a significant difference in system 800 is the delivery of advertisements by the media stream itself.

As shown in FIG. 8, instead of or in addition to, forwarding advertisements to user devices 106, the advertisement server 110 delivers the advertisements for the user devices 106 to the media server 104. The advertisements delivered by advertisement server 110 can be configured to be associated with particular devices or groups of devices based on channel characteristics, demographic characteristics, behavioral characteristics, and spatial-temporal characteristics. The media server 104 can then insert the advertisement into the media stream. This process is described below with respect to FIG. 9.

FIG. 9 is a flowchart of steps in an exemplary method 900 for inserting advertisements and other invitational content items into a broadcast media stream, such as broadcast media stream associated with a live event.

Typically insertion of additional content into a broadcast media stream associated with a live event is difficult since: (1) the interruption or delays in the delivery of the broadcast media stream is not acceptable; (2) the identification of a suitable location in the media stream can be difficult; or (3) the insertion may interfere with existing invitational content items in the media stream. Accordingly, the present disclosure contemplates an alternate methodology for such insertions, as described below in method 900.

Method 900 begins at step 902 and proceeds to step 904. At step 904, media server 104 receives the broadcast media stream from third party content provider 102 as a sequence of segments, which includes tags for at least some of the segments. Thereafter, at step 906, the broadcast of the media stream to the user devices 106 can begin, where the media stream is delivered by the media server segment-by-segment.

Before, after, or during steps 904 and 906, the media server 104 can receive invitational content items for the user devices from advertisement server 110 at step 908. Each of the invitational content items can be configured to explicitly target one or more of user devices 106. In some cases, the invitational content items can be provided by the advertisement server 110 in response to previous notifications or requests received during previous portions of the media stream, as discussed above with respect to FIG. 5. In other cases, the invitational content items can be independently generated. For example, the advertisement server 110 can be aware of the media stream and can identify advertisement suitable for users likely to be requesting access to the media stream.

Regardless of how the additional invitational content is generated, the method proceeds to step 910 to begin the process of insertion. At step 910, a determination is made as to whether a next segment of the broadcast media stream is suitable for insertion of an additional invitational content item. This determination can be made on a device-by-device basis or for groups of devices.

It should be noted that depending on the streaming technology being utilized, an invitational content item may actually be associated with a plurality of consecutive segments. Accordingly, the determination at step 910 can include consideration of all related segments. Thus, a “segment” as referred to in FIG. 9 and throughout the present disclosure can encompass multiple consecutive segments.

The determination at step 910 can involve various analyses. Some analyses can involve a determination of whether an additional item of invitational content is compatible with a particular user device. For example, the additional invitational content item may be unsuitable based on a channel characteristic, a demographic characteristic, a behavioral characteristic, or a spatial-temporal characteristic. Other analyses can involve a determination as to whether the additional item of invitational content is conflicts with invitational content items already embedded within the media stream. For example, a conflict can occur if the additional invitational content item and the invitational content item in the media stream are both advertisements for different brands of the same or similar products, i.e., competing products.

In some configurations, the tags in the media stream can control the insertion of advertisements into the media stream. For example, a tag associated with a media stream can indicate that a particular segment should or should not be associated with an insertion of additional invitational content items. In another example, the tag can also indicate particular criteria for insertion. That is, the tag can limit inserted invitational content items solely to items meeting certain criteria.

It should be noted that although one option of the insertion process is to add additional items of invitational content to a media stream, the present disclosure also contemplates the replacement of embedded items of invitational content in the media stream, either as part of the tags or as part of the media stream, but without adversely interfering with the content of the media stream. For example, consider a broadcast media stream presented to user devices located in different geographic regions. In many cases, the broadcast media stream may include embedded advertisements that appeal to users in the different geographic regions. However, in certain cases, some of the embedded advertisements may only appeal only to users in a portion of the different geographic regions. In such cases, the tag can indicate that a particular segment is suitable for replacement by another advertisement. As a result, the media server 104 can replace the existing invitational content with new invitational content.

Referring back to FIG. 9, once the determination is made at step 910, the method 900 proceeds to step 912. If the next segment is unsuitable for insertion of an additional invitational content item, the method proceeds to step 914. At step 914, it is determined whether the broadcast media stream has been completed. If not yet completed, the method 900 proceeds back to step 910 to evaluate the next segment or group of segments. Optionally, the advertisement server 110 can provide new invitational content items for consideration. If the broadcast media stream has been completed, the method 900 can proceed to step 916 and resume previous processing, including repeating method 900.

Referring back to step 912, if the determination is made that a next segment or group of segments is suitable for insertion of an additional invitational content item, the method proceeds to step 918 to insert the item into the segment of the media stream. Thereafter, the modified segment is delivered to the requesting ones of user devices 106. The method 900 then proceeds to step 914 to continue processing, as described above.

As noted above, the insertion process can be completed in a variety of ways. In a first configuration, the insertion can entail adding a tag including the additional invitational content item or modifying an existing tag to include the item. Accordingly, the tag can cause the invocation of the invitational content item. In such a configuration, the tag can be configured to control how and when the invitational content item is presented. In a second configuration, the additional invitational content item can be inserted into the media stream itself to replace or modify segments associated with an existing invitational content item. A tag can then be added or modified to such a segment to cause a notification to be generated. In such a configuration, all users receiving the segment are exposed to the item of invitational content and the tag is utilized solely to generate the notification.

As to the second configuration, the insertion can be performed by leveraging the properties of the streaming technology being used For example, in HTTP Live Streaming, a broadcasted event is delivered via a collection of alternate media streams for the broadcast event, where each media stream is configured for supporting a particular device configurations, bit rates, etc. . . . Accordingly, when a media server receives a request for access to the broadcasted event, the appropriate one of the alternate media streams is selected based on the requesting device, quality of the connection, and other criteria. In the event that there is a change in the connection to the media server or the configuration of the device, the media server can switch to a different one of the alternate media stream in order to maintain the broadcast of the event going. Thus, since HTTP Live Streaming is already enabled to support interchangeable segments, the replacement of a particular segment with one including additional invitational content can be performed without requiring significant modification of a media server or devices accessing the media server.

It should be noted that the arrangement of components in FIGS. 1, 5, and 8 is presented solely by way of example and not by way of limitation. In particular, the analysis/metrics 108 need not be a separate component. In some configurations, the analysis/metrics system can be a part of advertisement server 110, or other content delivery system, part of third party content provider 108, or part of media server 104. Moreover, the operations of analysis/metrics 108 can also be divided among one or snore of the components in FIGS. 1, 5, and 8, including user devices 106 or other devices not explicitly illustrated in FIGS. 1, 5, and 8.

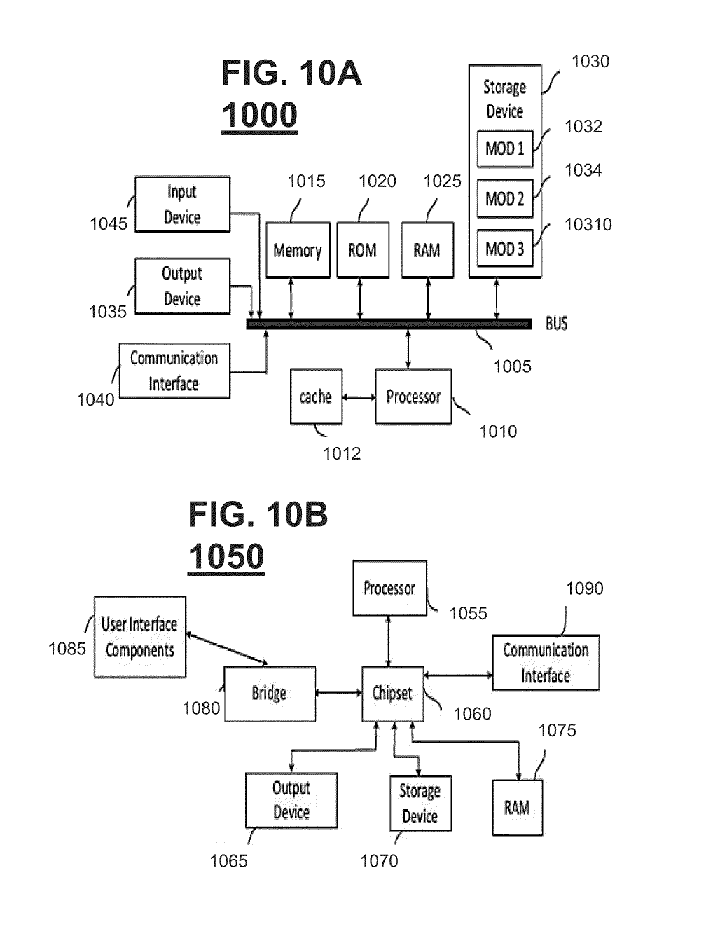

FIG. 10A, and FIG. 10B illustrate exemplary possible system configurations. The more appropriate configuration will be apparent to those of ordinary skill in the art when practicing the present technology. Persons of ordinary skill in the art will also readily appreciate that other system configurations are possible.

FIG. 10A illustrates a conventional system bus computing system architecture 1000 wherein the components of the system are in electrical communication with each other using a bus 1005. Exemplary system 1000 includes a processing unit (CPU or processor) 1010 and a system bus 1005 that couples various system components including the system memory 1015, such as read only memory (ROM) 1020 and random access memory (RAM) 1025, to the processor 1010. The system 1000 can include a cache of high-speed memory connected directly with, in close proximity to, or integrated as part of the processor 1010. The system 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware module or software module, such as module 1 1032, module 2 1034, and module 3 1036 stored in storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction with the computing device 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing device 1000. The communications interface 1040 can generally govern and manage the user input and system output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof.

The storage device 1030 can include software modules 1032, 1034, 1036 for controlling the processor 1010. Other hardware or software modules are contemplated. The storage device 1030 can be connected to the system bus 1005. In one aspect, a hardware module that performs a particular function can include the software component stored in a computer-readable medium in connection with the necessary hardware components, such as the processor 1010, bus 1005, display 1035, and so forth, to carry out the function.

FIG. 10B illustrates a computer system 1050 having a chipset architecture that can be used in executing the described method and generating and displaying a graphical user interface (GUI). Computer system 1050 is an example of computer hardware, software, and firmware that can be used to implement the disclosed technology. System 1050 can include a processor 1055, representative of any number of physically and/or logically distinct resources capable of executing software, firmware, and hardware configured to perform identified computations. Processor 1055 can communicate with a chipset 1060 that can control input to and output from processor 1055. In this example, chipset 1060 outputs information to output 1065, such as a display, and can read and write information to storage device 1070, which can include magnetic media, and solid state media, for example. Chipset 1060 can also read data from and write data to RAM 1075. A bridge 1080 for interfacing with a variety of user interface components 1085 can be provided for interfacing with chipset 1060. Such user interface components 1085 can include a keyboard, a microphone, touch detection and processing circuitry, a pointing device, such as a mouse, and so on. In general, inputs to system 1050 can come from any of a variety of sources, machine generated and/or human generated.

Chipset 1060 can also interface with one or more communication interfaces 1090 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1055 analyzing data stored in storage 1070 or 1075. Further, the machine can receive inputs from a user via user interface components 1085 and execute appropriate functions, such as browsing functions by interpreting these inputs using processor 1055.

It can be appreciated that exemplary systems 1000 and 1050 can have more than one processor 1010 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some configurations the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can he implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A computer-implemented method, comprising:
obtaining at least one notification associated with at least one device from a plurality of devices accessing a broadcast media stream comprising a sequence of segments, the at least one notification comprising tag data and device data, the tag data comprising first metadata for at least one invitational content item embedded within a one of the sequence of segments that has been delivered to the at least one device, and the device data comprising second metadata for the at least one device;
computing exposure statistics for the at least one invitational content item among the plurality of devices based on the plurality of notifications; and
reporting the exposure statistics for each of the at least one invitational content item.

2. The method of claim 1, wherein the first metadata further comprises information regarding a position of the at least one invitational content item within the broadcast media stream.

3. The method of claim 1, wherein the second metadata comprises at least one of channel characteristics, demographic characteristics, behavioral characteristics, and spatial-temporal characteristics.

4. The method of claim 1, further comprising:
for at least one device, generating a request for at least one additional invitational content item based the at least one notification associated with a current one of the sequence of segments.

5. The method of claim 4, wherein the generating of the request comprises:
identifying a subject matter for the at least one additional item of invitation content based the tag data; and
assembling the request to specify the subject matter and the device data.

6. The method of claim 1, wherein the exposure statistics are reported to at least one of a source of the media stream or a third party associated with the at least one invitational content item.

7. The method of claim 1, wherein the exposure statistics comprise at least one of a number of the plurality of devices receiving the at least one invitational content item, at least one relative measure of a number of times the plurality of devices received the at least one invitational content item, at least one relative measure of an amount of the broadcast media stream delivered to the plurality of devices.

8. A computer-implemented method, comprising
receiving, from a content provider, a broadcast media stream comprising a sequence of segments and a plurality of tags, each of the plurality of tags associated with a different one of the sequence of segments, and each of the plurality of tags storing metadata for at least one invitational content item embedded within the associated one of the sequence of segments;
forwarding a current segment of the sequence of segments to a plurality of user devices currently accessing the broadcast media stream;
detecting whether the current segment comprises one of the plurality of tags; and
transmitting, to an analysis system, a notification corresponding to one of the plurality of user devices receiving the current segment, the notification comprising tag data and device data, the tag data comprising first metadata for at least one invitational content item embedded within the current segment and the device data comprising second metadata for the corresponding device.

9. The method of claim 1, wherein the first metadata further comprises information regarding a position of the at least one invitational content item within the broadcast media stream.

10. The method of claim 1, wherein the second metadata comprises at least one of channel characteristics, demographic characteristics, behavioral characteristics, and spatial-temporal characteristics.

11. A communications device, comprising:
a communications interface;
a processor; and
a computer-readable medium having stored therein a plurality of instructions for causing the processor to perform the steps of:
requesting, via the communications interface, a broadcast media stream from a content provider,
receiving a current segment of a sequence of segments defining the broadcast media stream via the communications interface, the broadcast media stream further comprising a plurality of tags each associated with a different one of the sequence of segments, and each of the plurality of tags storing metadata for at least one invitational content item embedded within the associated one of the sequence of segments,
detecting whether the current segment comprises one of the plurality of tags; and
upon detected that the current segment comprises one of the plurality tags,
transmitting, to an analysis system, a notification comprising tag data and device data, the tag data comprising first metadata for at least one invitational content item embedded within the current segment and the device data comprising second metadata for the communications device.

12. The device of claim 11, wherein the first metadata further comprises information regarding a position of the at least one invitational content item within the broadcast media stream.

13. The device of claim 11, wherein the second metadata comprises at least one of channel characteristics, demographic characteristics, behavioral characteristics, and spatial-temporal characteristics.

14. The device of claim 11, wherein the current segment is configured to invoke at least one additional invitational content item, and wherein the computer-readable medium further comprises instructions for causing the processor to perform the steps of:
obtaining, from a content delivery system, the at least one additional invitational content item using a request specifying a subject matter for the at least one additional item of invitation content corresponding to the tag data for the one of the plurality of tags, and
presenting the at least one additional invitational content item at the communications device.

15. The device of claim 11, wherein the current segment comprises at least one additional invitational content item, and wherein the computer-readable medium further comprises instructions for causing the processor o presenting the at least one additional invitational content item at the communications device.

16. A system, comprising:
a communications interface;
a processor; and
a computer-readable medium having stored therein a plurality of instructions for causing the processor to perform the steps of:
receiving, via the communications interface, at least one notification associated with at least one device from a plurality of devices accessing a broadcast media stream comprising a sequence of segments, the at least one notification comprising tag data and device data, the tug data comprising first metadata for at least one invitational content item embedded within a one of the sequence of segments that has been delivered to the at least one device, and the device data comprising second metadata for the at least one device;
computing exposure statistics for the at least one invitational content item among the plurality of devices based on the plurality of notifications; and
reporting the exposure statistics for each of the at least one invitational content item.

17. The system of claim 16, wherein the first metadata further comprises information regarding a position of the at least one invitational content item within the broadcast media stream.

18. The system of claim 16, wherein the second metadata comprises at least one of channel characteristics, demographic characteristics, behavioral characteristics, and spatial-temporal characteristics.

19. The system of claim 16, further comprising:
for at least one device, obtaining at least one additional invitational content item based the at least one notification associated with a current one of the sequence of segments.

20. The system of claim 16, wherein the obtaining comprises:
selecting a subject matter for the at least one additional item of invitation content based the tag data; and
identifying the at least one additional invitational content item from a plurality of candidate invitational content items based at least on the subject matter and the device data.

21. The system of claim 16, wherein the exposure statistics comprise at least one of a number of the plurality of devices receiving the at least one invitational content item, at least one relative measure of a number of times the plurality of devices received the at least one invitational content item, at least one relative measure of an amount of the broadcast media stream delivered to the plurality of devices.

22. A non-transitory computer-readable medium having stored thereon a computer program executable on a computer, the computer program comprising a plurality of code sections for causing the computer to perform the steps of:
obtaining a broadcast media stream comprising a sequence of segments and a plurality of tags, each of the plurality of tags associated with a different one of the sequence of segments, and each of the plurality of tags storing metadata for at least one invitational content item embedded within the associated one of the sequence of segments;
forwarding a current segment of the sequence of segments to a plurality of user devices currently accessing the broadcast media stream;
detecting whether the current segment comprises one of the plurality of tags; and
generating notifications for each of the plurality of user devices receiving the current segment, the notifications comprising tag data and device data, the tag data comprising first metadata for at least one invitational content item embedded within the current segment and the device data comprising second metadata for the corresponding device.

23. The computer-readable medium of claim 22, wherein the first metadata further comprises information regarding a position of the at least one invitational content item within the broadcast media stream.

24. The computer-readable medium of claim 22, wherein the second metadata comprises at least one of channel characteristics, demographic characteristics, behavioral characteristics, and spatial-temporal characteristics.

25. The computer-readable medium of claim 22, further comprising code sections for causing the computer to perform the steps of:
based on the notifications, computing exposure statistics for the at least one invitational content item among the plurality of devices; and
reporting the exposure statistics for each of the at least one invitational content item.
